(19) United States
(12) Patent Application Publication
(10) Pub. No.: US 2021/0004235 A1
(43) Pub. Date: Jan. 7, 2021

(54) OPTIMIZING SOFTWARE-DIRECTED INSTRUCTION REPLICATION FOR GPU ERROR DETECTION

(71) Applicant: NVIDIA Corp., Santa Clara, CA (US)

(72) Inventors: Siva Kumar Sastry Hari, Sunnyvale, CA (US); Michael Sullivan, Austin, TX (US); Timothy Tsai, Santa Clara, CA (US); Stephen W. Keckler, Austin, TX (US)

(73) Assignee: NVIDIA Corp., Santa Clara, CA (US)

(21) Appl. No.: 17/024,683

(22) Filed: Sep. 17, 2020

Related U.S. Application Data
(63) Continuation-in-part of application No. 16/150,410, filed on Oct. 3, 2018, now Pat. No. 10,817,289.
(60) Provisional application No. 62/567,564, filed on Oct. 3, 2017.

(51) Int. Cl. G06F 9/38; G06F 9/30; G06F 9/48; G06F 11/14; G06F 11/07

(52) U.S. Cl. CPC G06F 9/3861; G06F 9/3009; G06F 11/0772; G06F 11/1407; G06F 9/4812

(57) ABSTRACT

A thread execution method in a processor includes executing original instructions of a first thread in a first execution lane of the processor, and interleaving execution of duplicated instructions of the first thread with execution of original instructions of a second thread in a second execution lane of the processor.

### CROSS-REFERENCE TO RELATED APPLICATIONS

This application claims priority and benefit as a continuation-in-part of U.S. application Ser. No. 16/150,410 filed on Oct. 3, 2018, the contents of which are incorporated by reference herein in their entirety. Application Ser. No. 16/150,410 claims priority and benefit under 35 U.S.C. 119 to U.S. application Ser. No. 62/567,564, filed on Oct. 3, 2017, the contents of which are incorporated herein by reference in their entirety.

### BACKGROUND

Transient hardware errors from high-energy particle strikes (also known as soft-errors) are of concern for high performance and safety-critical systems because they can silently corrupt execution results. Any application with large scale running on high performance computing (HPC) systems in terms of memory and resource usage will be vulnerable to an error rate that is roughly proportional to the scale. Some HPC systems are required to demonstrate very low error levels. As graphics processing units (GPUs) become more pervasive in such systems, designers must ensure that the computations that are offloaded to them are resilient to transient errors. The state-of-the-art GPUs used in these markets employ error correcting code (ECC) or parity protection for major storage structures such as dynamic random-access memory (DRAM), caches, and the register file. Without data path reliability mechanisms, however, such systems may not be able to maintain high reliability at future error rates and system scales.

Prior software-based techniques to address these issues have introduced redundancy through software at multiple granularities, such as at the process, GPU kernel, thread, and assembly instruction level. Process-level redundancy replicates the process and compares results at system call boundaries. This approach suffers from limitations for multi-threaded workloads. Kernels or thread blocks can be re-executed and their outputs then compared to ensure correctness. This approach is challenging for workloads where the kernel or block outputs are non-deterministic, which can arise from rounding errors and reading clock values during execution, for example.

Thread-level duplication (also called redundant multithreading or RMT) has also been employed for central processing units (CPUs) and GPUs. Researchers have shown that an automatic compiler transformation can be used to create redundant threads, managing both communication and synchronization of operations that exit the sphere-of-replication. On GPUs, duplicating at the thread level produces high overhead due to cross-block communication and synchronization overhead.

While the thread-level duplication has lower overhead, programmers must ensure that the spare hardware resources are available because streaming multiprocessors support a fixed number of threads per thread block. If the duplicated thread is placed within the same warp, the original warp must be split into two warps, which affects programs that rely on intra-warp communication constructs such as warp vote and shuffle operations.

Software instruction-level duplication has been explored for CPUs, but not GPUs. Techniques have been proposed to duplicate instructions at the assembly level and insert checking instructions to validate the results for CPUs. Others have proposed a compiler-based approach and exploited wide, underutilized processors by scheduling both original and duplicated instructions in the same CPU thread.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram of a computing system 100 within which the techniques introduced herein may be embodied or carried out.

FIG. 2 depicts a parallel processing architecture 200 in accordance with one embodiment.

FIG. 3 depicts a first-type integrity verifier 300 in accordance with one embodiment.

FIG. 4 depicts another second-type integrity verifier 400 routine in accordance with one embodiment.

FIG. 5 depicts another third-type integrity verifier 500 routine in accordance with one embodiment.

FIG. 6 depicts various logic for verifying data flow integrity in a data processor.

FIG. 7 depicts a code compiler algorithm 700 and linker to generate executable code logic of NVIDIA® GPUs in accordance with one embodiment.

FIG. 8 depicts a PTAX compiler pass 800 in accordance with one embodiment.

FIG. 9A depicts conventional instruction-level duplication 900a in accordance with one embodiment.

FIG. 9B depicts conventional thread level duplication 900b in accordance with one embodiment.

FIG. 10 depicts swizzled instruction duplication 1000 in accordance with one embodiment.

FIG. 11 depicts control divergence code 1100 in accordance with one embodiment.

FIG. 12 depicts reducing verification overhead 1200 in accordance with one embodiment.

FIG. 13 depicts verification code 1300 in accordance with one embodiment.

FIG. 14A depicts signature update code in accordance with one embodiment.

FIG. 14B depicts hardware-accelerated signature update in accordance with one embodiment.

FIG. 15 depicts a mission-critical control system 1502 in accordance with one embodiment.

FIG. 16 depicts a data center 1600 in accordance with one embodiment.

### DETAILED DESCRIPTION

The following three factors are large contributors of overhead to assembly-level instruction duplication in GPUs:
1. additional verification and notification instructions;
2. increased register requirements per thread (due to duplicated register space); and
3. duplicated instructions.

To mitigate the overhead incurred from additional verification and notification instructions, an optimization is disclosed to defer error notification, with no loss in error coverage. A flag is created and reset once, before the first error check instruction, which in one embodiment is at the beginning of the GPU kernel. This flag is set on any original and redundant values mismatch. For load/store implementations, the original and redundant values to compare will typically be stored in registers, however, other embodiments may compare instruction output values stored in different locations, such as the memory hierarchy (Level 1 cache, MMU etc.) At the end of the kernel a trap is raised to notify the higher level (e.g., GPU device driver of the operating system) if the flag is set. Comparing the two register values and updating the flag are fast operations, for example implemented by performing an XOR between the two register values and ORing the result with the flag using a single LOP3 operation. This may be referred to as a “software-only” optimization.

Increasing the register requirement per thread may significantly affect performance for some workloads where the register file is a critical resource (the second overhead source). A trade off may be made between the number of additional verification instructions, and register usage. Embodiments disclosed herein may reduce the average runtime register overhead to 35%, for example.

The software-only optimization may compromise error containment for performance. In another embodiment, an instruction set architecture (ISA) extension may be utilized for error containment without loss in coverage and performance. To this end, an embodiment comprising an instruction that compares two values and raises a trap in hardware is disclosed.

An embodiment comprising a second ISA extension is also disclosed, comprising hardware changes to the GPU Streaming Multiprocessor (SM) to eliminate the need for verification and notification instructions, without sacrificing error coverage. This extension accelerates the software-only optimization by maintaining the flag in hardware and incorporating each of the original and redundant instructions to XOR the result into the flag. Once all the instructions have executed (same number of original and redundant) the flag register should (in fault-free scenarios) have a zero value. This scheme, like the software-only optimization, relaxes error containment somewhat. The average runtime overhead of this technique is 28%.

In summary, the following embodiments are disclosed herein:
1. A GPU-specific software optimization that performs fast compare and flag update operation using a single GPU instruction (LOP3);
2. An ISA extension such that two register values may be compared and a trap (e.g., an interrupt or other assertion instruction) may be raised on a value mismatch; and
3. An ISA extension and hardware support to maintain the flag register in hardware to eliminate the use of verification instructions altogether. The flag register may be either a general-purpose register or a dedicated flag register. A dedicated register may be preferred as it introduces relatively low die area overhead to the GPU, and provides faster access, no general-purpose register contention).

In one embodiment a thread execution method involves executing original instructions of a first thread in a first execution lane of a processor and interleaving execution of duplicated instructions of the first thread with execution of original instructions of a second thread in a second execution lane of the processor. The method may further involve execution of duplicated instructions of a third thread with execution of the original instructions of the first thread in the first execution lane of the processor. In other words, generally, duplicated instructions for each execution lane may be interleaved with original instructions in a different execution lane of the processor.

An integrity verification in accordance with the techniques described herein may be performed on results of the execution of the original instructions of the first thread and results of the execution of the duplicated instructions of the first thread. The integrity verification may be triggered by reaching by exit point of the first thread—in other words, at some point subsequent to or at execution of the exit point. “Exit point” refers to a defined location in a thread for returning execution flow from a call to a subroutine, function, or other block of instructions. Exit points are well known in the computational arts.

The thread execution method may generally involve, for each of threads i being executed by the processor (i=1 to N, N>2): executing original instructions of thread i in an i^{th} execution lane of the processor, and interleaving execution of duplicated instructions of thread i with execution of original instructions of thread i+1 in an (i+1)^{th} execution lane of the processor. Duplicated instructions of a thread N+1 may be interleaved with execution of original instructions of the first thread in the first execution lane of the processor. The method may also involve performing a shift of an active thread mask across execution lanes of the processor. The shift may be a modulo (N+1) shift.

A system to carry out such methods may include a multi-processor comprising a first execution lane, a second execution lane, and a third execution lane, logic to interleave execution by the multi-processor of duplicated instructions of a first thread in the first execution lane with execution by the multi-processor of original instructions of a second thread in the second execution lane, and logic to interleave execution by the multi-processor of duplicated instructions of the second thread with execution by the multi-processor of original instructions of a third thread in the third execution lane.

The system may include logic to perform a comparison of results of the execution of the original instructions of the first thread and results of the execution of the duplicated instructions of the first thread and logic to raise an error alert based on the comparison. “Alert” refers to any signal indicating detection of a tested-for condition.

A parallel processor to carry out such methods may include logic to duplicate original instructions of a first thread executing in a first execution lane of a processor into duplicate instructions and to interleave the duplicate instructions between original instructions of a second thread executing in a second execution lane of the processor, logic to accumulate results (first results) for the original instructions of the first thread, logic to accumulate second results for the duplicate instructions; logic to perform a test, subsequent to an exit point of the first thread, based on the first results and the second results; and logic to raise an alert if the test meets a condition. “Accumulate results” refers to any tracking of results of instruction execution. Accumulate results does not necessarily mean performing a summation, and may include tracking differences between results of instructions and other techniques that capture the net or gross results of executing a number of instructions.

The system may include a dedicated register for each of the execution lanes in which to accumulate the first results and the second results respectively. Alternatively, the system may include a shared register for the execution lanes in which to accumulate the first results and the second results, and may include logic to initialize the shared register to a predetermined initial value at a kernel launch time using a synchronous reset signal and to perform the test when execution of the kernel concludes. Logic for binary Galois Field arithmetic utilizing XOR operations may be utilized to compute the first results and the second results. The test may be based only on ECC bits of the first results and the second results, and may be performed in a pipeline stage of the parallel processor following ECC encoding.

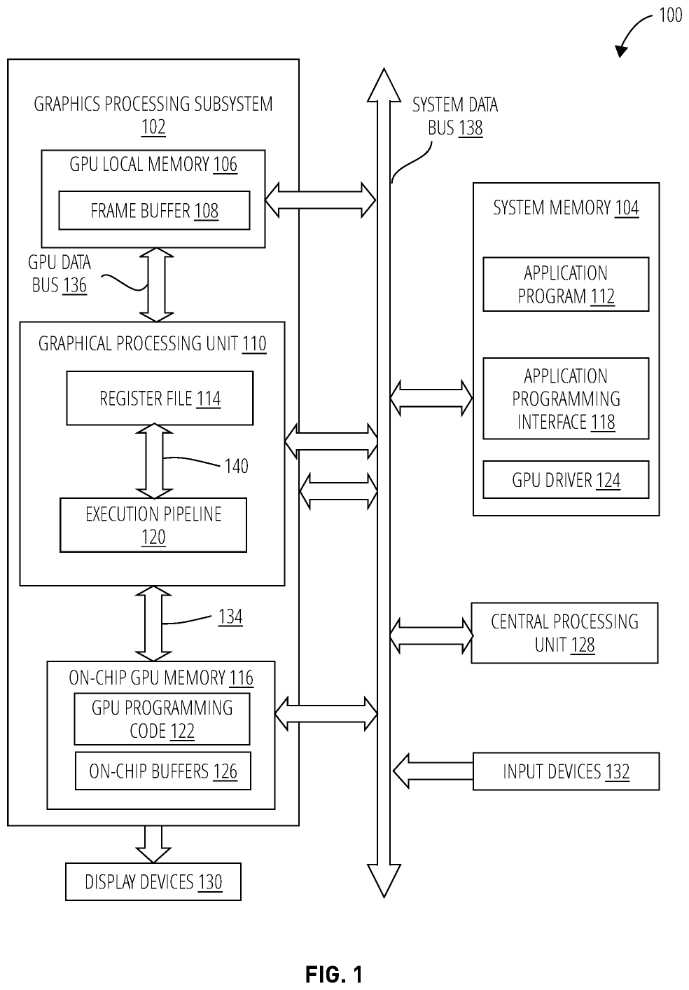

FIG. 1 is a block diagram of one embodiment of a computing system 100 in which one or more aspects of the invention may be implemented or carried out. The computing system 100 includes a system data bus 138, a CPU 128, input devices 132, a system memory 104, a graphics processing subsystem 102, and display devices 130. In alternate embodiments, the CPU 128, portions of the graphics processing subsystem 102, the system data bus 138, or any combination thereof, may be integrated into a single processing unit. Further, the functionality of the graphics processing subsystem 102 may be included in a chipset or in some other type of special purpose processing unit or co-processor.

As shown, the system data bus 138 connects the CPU 128, the input devices 132, the system memory 104, and the graphics processing subsystem 102. In alternate embodiments, the system memory 104 may connect directly to the CPU 128. The CPU 128 receives user input from the input devices 132, executes programming instructions stored in the system memory 104, operates on data stored in the system memory 104, and configures the graphics processing subsystem 102 to perform specific tasks in an execution pipeline. The system memory 104 typically includes dynamic random access memory (DRAM) employed to store programming instructions and data for processing by the CPU 128 and the graphics processing subsystem 102. The graphics processing subsystem 102 receives instructions transmitted by the CPU 128 and processes the instructions to perform various graphics and computational tasks.

As also shown, the system memory 104 includes an application program 112, an API 118 (application programming interface), and a graphics processing unit driver 124 (GPU driver). The application program 112 generates calls to the API 118 to produce a desired set of results. The API 118 functionality is typically implemented within the graphics processing unit driver 124.

The graphics processing subsystem 102 includes a GPU 110 (graphics processing unit), an on-chip GPU memory 116, an on-chip GPU data bus 134, a GPU local memory 106, and a GPU data bus 136. The GPU 110 is configured to communicate with the on-chip GPU memory 116 via the on-chip GPU data bus 134 and with the GPU local memory 106 via the GPU data bus 136. The GPU 110 may receive instructions transmitted by the CPU 128, process the instructions, and store results in the GPU local memory 106.

The GPU 110 includes one or more register file 114 and execution pipeline 120 that interact via an on-chip bus 140. The various error detecting and correcting schemes disclosed herein detect and in some cases correct for data corruption that takes place in the execution pipeline 120, during data exchange over the on-chip bus 140, and for data storage errors in the register file 114.

The GPU 110 may be provided with any amount of on-chip GPU memory 116 and GPU local memory 106, including none, and may employ on-chip GPU memory 116, GPU local memory 106, and system memory 104 in any combination for memory operations.

The on-chip GPU memory 116 is configured to include GPU programming 122 and on-Chip Buffers 126. The GPU programming 122 may be transmitted from the graphics processing unit driver 124 to the on-chip GPU memory 116 via the system data bus 138. The on-Chip Buffers 126 are typically employed to store data that requires fast access to reduce the latency of the processing in the graphics pipeline. Because the on-chip GPU memory 116 takes up valuable die area, it is relatively expensive.

The GPU local memory 106 typically includes less expensive off-chip dynamic random-access memory (DRAM) and is also employed to store data and programming employed by the GPU 110. As shown, the GPU local memory 106 includes a frame buffer 108. The frame buffer 108 stores data for data that may be applied to drive the display devices 130.

The display devices 130 are one or more output devices capable of emitting a visual image corresponding to an input data signal. For example, a display device may be built using a cathode ray tube (CRT) monitor, a liquid crystal display, or any other suitable display system. The input data signals to the display devices 130 are typically generated by scanning out the contents of one or more frames of image data that is stored in the frame buffer 108.

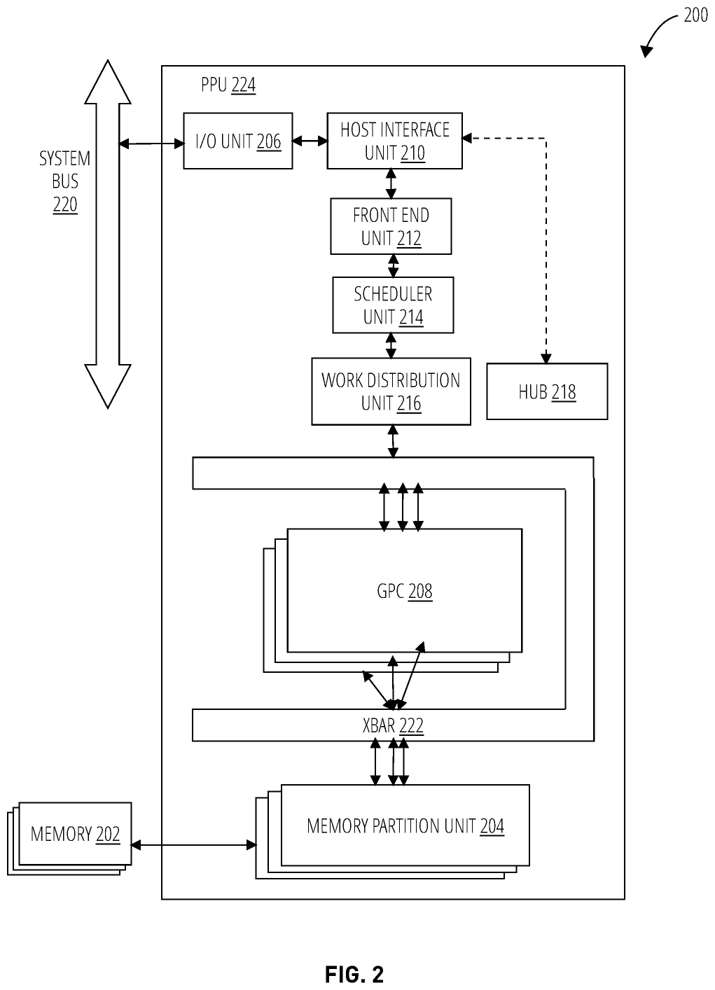

FIG. 2 depicts a parallel processing architecture 200 in accordance with one embodiment, in which the various schemes disclosed herein may be implemented or utilized. In one embodiment, the parallel processing architecture 200 includes a parallel processing unit (PPU 224) that is a multi-threaded processor implemented on one or more integrated circuit devices. The parallel processing architecture 200 is a latency reducing architecture designed to process a large number of threads in parallel. A thread (i.e., a thread of execution) is an instantiation of a set of instructions configured to be executed by the parallel processing architecture 200. In one embodiment, the PPU 224 is a graphics processing unit (GPU) configured to implement a graphics rendering pipeline for image data for display on a display device such as a liquid crystal display (LCD) device. In other embodiments, the parallel processing architecture 200 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

As shown in FIG. 2, the PPU 224 includes an I/O unit 206 (input/output unit), a host interface unit 210, a front end unit 212, a scheduler unit 214, a work distribution unit 216, a hub 218, an xbar 222 (crossbar), one or more GPC 208 (general processing cluster), and one or more memory partition unit 204. The PPU 224 may be connected to a host processor or other peripheral devices via a system bus 220. The PPU 224 may also be connected to a local memory comprising a number of memory devices 202. In one embodiment, the local memory may comprise a number of dynamic random-access memory (DRAM) devices.

The I/O unit 206 is configured to transmit and receive communications (i.e., commands, data, etc.) from a host processor (not shown) over the system bus 220. The I/O unit 206 may communicate with the host processor directly via the system bus 220 or through one or more intermediate devices such as a memory bridge. In one embodiment, the I/O unit 206 implements a Peripheral Component Interconnect Express (PCIe) interface for communications over a PCIe bus. In alternative embodiments, the I/O unit 206 may implement other types of well-known interfaces for communicating with external devices.

The I/O unit 206 is coupled to a host interface unit 210 that decodes packets received via the system bus 220. In one embodiment, the packets represent commands configured to cause the PPU 224 to perform various operations. The host interface unit 210 transmits the decoded commands to various other units of the parallel processing architecture 200 as the commands may specify. For example, some commands may be transmitted to the front end unit 212. Other commands may be transmitted to the hub 218 or other units of the PPU 224 such as one or more copy engines, a video encoder, a video decoder, a power management unit, etc. (not explicitly shown). In other words, the host interface unit 210 is configured to route communications between and among the various logical units of the PPU 224.

In one embodiment, a program executed by the host processor encodes a command stream in a buffer that provides workloads to the PPU 224 for processing. A workload may comprise a number of instructions and data to be processed by those instructions. The buffer is a region in a memory that is accessible (i.e., read/write) by both the host processor and the PPU 224. For example, the host interface unit 210 may be configured to access the buffer in a system memory connected to the system bus 220 via memory requests transmitted over the system bus 220 by the I/O unit 206. In one embodiment, the host processor writes the command stream to the buffer and then transmits a pointer to the start of the command stream to the PPU 224. The host interface unit 210 provides the front-end unit 212 with pointers to one or more command streams. The front-end unit 212 manages the one or more streams, reading commands from the streams and forwarding commands to the various units of the PPU 224.

The front-end unit 212 is coupled to a scheduler unit 214 that configures the GPC 208 to process tasks defined by the one or more streams. The scheduler unit 214 is configured to track state information related to the various tasks managed by the scheduler unit 214. The state may indicate which GPC 208 a task is assigned to, whether the task is active or inactive, a priority level associated with the task, and so forth. The scheduler unit 214 manages the execution of a plurality of tasks on the one or more GPC 208.

The scheduler unit 214 is coupled to a work distribution unit 216 that is configured to dispatch tasks for execution on the GPC 208. The work distribution unit 216 may track a number of scheduled tasks received from the scheduler unit 214. In one embodiment, the work distribution unit 216 manages a pending task pool and an active task pool for each GPC 208. The pending task pool may comprise a number of slots (e.g., 16 slots) that contain tasks assigned to be processed by a particular GPC 208. The active task pool may comprise a number of slots (e.g., 4 slots) for tasks that are actively being processed by each GPC 208. As a GPC 208 finishes the execution of a task, that task is evicted from the active task pool for the GPC 208 and one of the other tasks from the pending task pool is selected and scheduled for execution on the GPC 208. If an active task has been idle on the GPC 208, such as while waiting for a data dependency to be resolved, then the active task may be evicted from the GPC 208 and returned to the pending task pool while another task in the pending task pool is selected and scheduled for execution on the GPC 208.

The work distribution unit 216 communicates with the one or more GPC 208 via an xbar 222. The xbar 222 is an interconnect network that couples many of the units of the PPU 224 to other units of the PPU 224. For example, the xbar 222 may be configured to couple the work distribution unit 216 to a particular GPC 208. Although not shown explicitly, one or more other units of the PPU 224 are coupled to the host interface unit 210. The other units may also be connected to the xbar 222 via a hub 218.

The tasks are managed by the scheduler unit 214 and dispatched to a GPC 208 by the work distribution unit 216. The GPC 208 is configured to process the task and generate results. The results may be consumed by other tasks within the GPC 208, routed to a different GPC 208 via the xbar 222, or stored in the memory devices 202. The results can be written to the memory devices 202 via the memory partition unit 204, which implement a memory interface for reading and writing data to/from the memory devices 202. In one embodiment, the PPU 224 includes a number U of memory partition unit 204 that is equal to the number of separate and distinct memory devices 202 coupled to the PPU 224.

In one embodiment, a host processor executes a driver kernel that implements an application programming interface (API) that enables one or more applications executing on the host processor to schedule operations for execution on the PPU 224. An application may generate instructions (i.e., API calls) that cause the driver kernel to generate one or more tasks for execution by the PPU 224. The driver kernel outputs tasks to one or more streams being processed by the PPU 224. Each task may comprise one or more groups of related threads, referred to herein as a warp. A thread block may refer to a plurality of groups of threads including instructions to perform the task. Threads in the same group of threads may exchange data through shared memory. In one embodiment, a group of threads comprises 32 related threads.

NVIDIA® GPU programming models utilize thousands of threads. Threads are grouped into 32-element warps to improve efficiency. The threads in each warp execute in a SIMT (single instruction, multiple thread) fashion, all fetching from a single Program Counter (PC) in the absence of divergent conditional branch instructions. Many warps are then assigned to execute concurrently on a single GPU core, or streaming multiprocessor (SM). A GPU consists of many SMs attached to a memory hierarchy that includes SM-local scratchpad memories and L1 caches, a shared L2 cache, and multiple DRAM channels. Different GPUs deploy differing numbers of SMs, L2 slices, and memory channels to differentiate on power and performance.

On GPUs manufactured by NVIDIA, users can design parallel programs using high-level programming languages such as CUDA or OpenCL. The code that executes on the GPU is referred to as a shader or kernel. Programmers use a front-end compiler, such as NVIDIA's NVVM, to generate intermediate code in a virtual ISA called parallel thread execution (PTX). PTX exposes the GPU as a data-parallel computing device by providing a stable programming model and instruction set for general purpose parallel programming, but it does not run directly on the GPU.

A backend compiler optimizes and translates PTX instructions into machine code that can run on the device. NVIDIA's native ISA is called SASS. For compute shaders, the backend compiler can be invoked in two ways: (1) ahead-of-time compilation of compute kernels via a PTX assembler (PTXAS), and (2) a JIT-time compiler in the display driver can compile a PTX representation of the kernel if it is available in the binary.

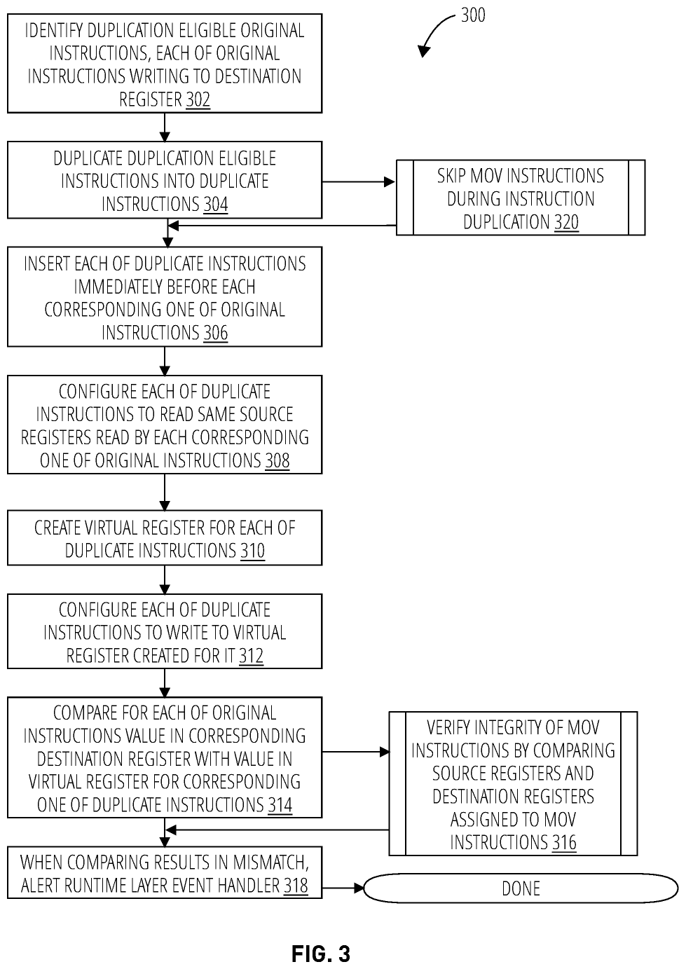

In the following description of FIGS. 3-5, reference is made to an “integrity verifier”. “Integrity verifier” in this context refers to the logic that generates the instrumented code to perform verification at runtime, not the instrumented code itself. Thus a process step such as “compare for each of the original instruction” is a step taken by the instrumented code when executed. The corresponding step of the integrity verifier is to generate one or more instructions to perform the comparison.

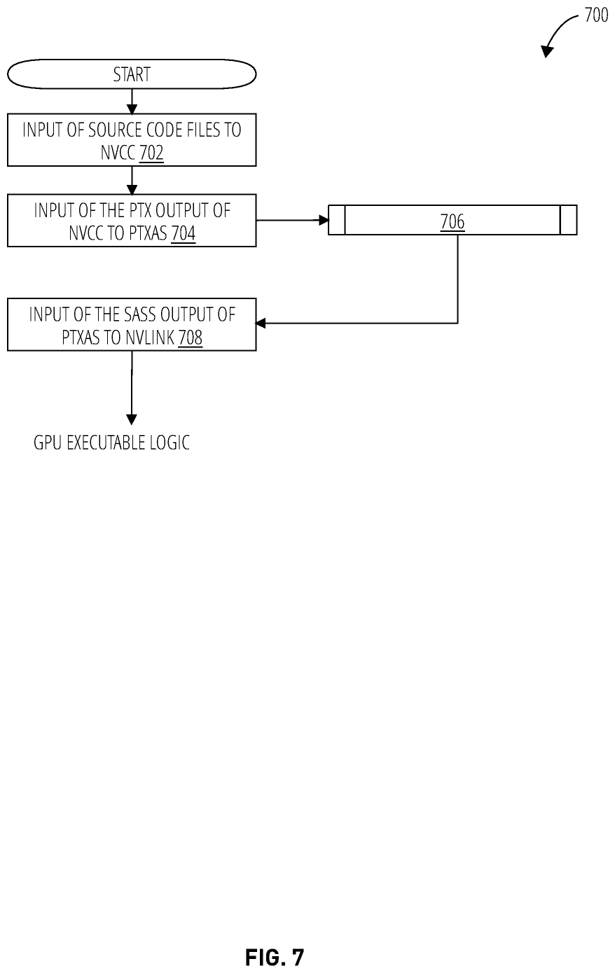

FIG. 3 depicts a first-type integrity verifier 300 (herein, also called “SRIV”, which is an abbreviation for Single Register space, Immediate Verification) in accordance with one embodiment. Duplicate instructions are created and inserted next to duplication eligible instructions. In block 302, the first-type integrity verifier 300 identifies duplication eligible original instructions, each writing to a destination register. In block 304, the first-type integrity verifier 300 duplicates the duplication eligible instructions into duplicate instructions. In block 306, first-type integrity verifier 300 inserts each of the duplicate instructions immediately before each corresponding one of the original instructions. This algorithm may be implemented in the back-end compiler (block 706 of FIG. 7).

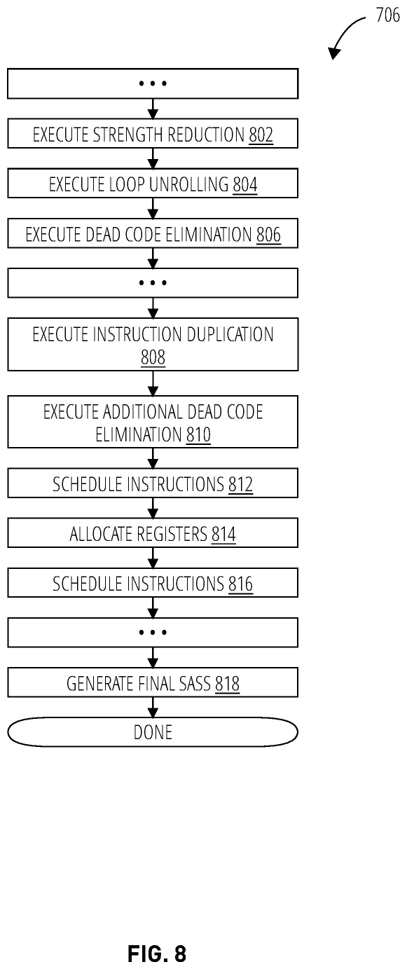

Virtual registers are created for the outputs of the duplicate instructions. The virtual registers are later mapped to physical registers (see block 814 of FIG. 8). Virtual registers are placeholder register references generated by the compiler that, at execution time, have been mapped to physical registers. In block 308, the first-type integrity verifier 300 configures each of the duplicate instructions to read the same source registers read by each corresponding one of the original instructions. In block 310, the first-type integrity verifier 300 creates a virtual register for each of the duplicate instructions. In block 312, the first-type integrity verifier 300 configures each of the duplicate instructions to write to the virtual register created for it.

Results of the duplicate instructions and original instructions are compared and an alert is raised if there is a mismatch. In block 314, the first-type integrity verifier 300 compares for each of the original instructions a value in the corresponding destination register with a value in the virtual register for the corresponding one of the duplicate instructions. In block 318, the first-type integrity verifier 300 detects when the comparing results in a mismatch, and alerts a runtime layer event handler. For example, the device driver may be notified for further action by an alert or interrupt instruction.

An optimization of the “SRIV” first-type integrity verifier 300 involves skipping duplication of MOV instructions (subroutine block 320), and verifying the integrity of the MOV instructions by comparing the source registers and destination registers of the un-duplicated MOV instructions (subroutine block 316).

The original destination registers are replaced in the duplicate instructions with virtual registers. Because the original instruction may overwrite its source operand and the duplicate instruction should generate the same result as the original instruction using the same source operands, the duplicate instruction is inserted before the original instruction. Next, verification instructions are inserted to compare the original and virtual register values after the original instruction. Verification and notification involve a comparison operation, a conditional branch instruction, and a trap instruction (e.g., BPT) to notify error-handling logic (e.g., a runtime layer executed by the GPU or CPU) of an error.

The runtime overhead of instruction duplication has three main contributors: (1) verification and notification instructions, (2) increased register requirements per thread, and (3) duplicated instructions.

To address the first overhead source, optimizations are herein disclosed that reduce the runtime overhead due to verification and notification instructions, by deferring error checking, with no loss in error coverage. The first-type integrity verifier 300 may increase the register requirement per thread to an extent that significantly affects performance for workloads where the register file is a critical resource. Thus, a possible tradeoff is between a number of verification instructions and register usage. Efficient hardware extensions are disclosed to speed up the verification and notification instructions beyond what the software optimizations achieve. Also disclosed is a hardware option to eliminate the first two sources of overhead altogether.

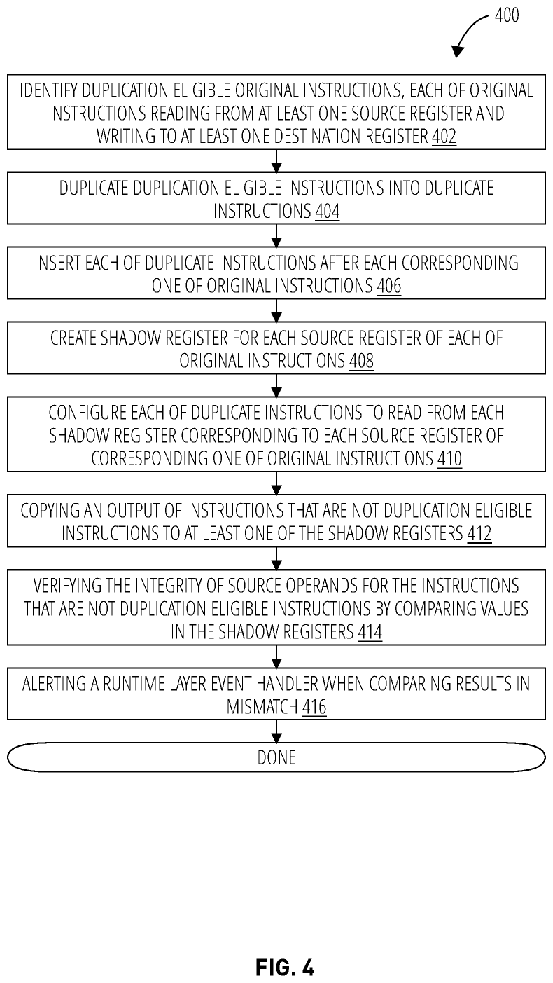

FIG. 4 depicts a second-type integrity verifier 400 routine (herein, also called “DRDV”, which is an abbreviation for Double Register space, Delayed Verification) in accordance with one embodiment. Duplicate instructions are created and inserted next to duplication eligible instructions. In block 402, the second-type integrity verifier 400 identifies duplication eligible original instructions, each of the original instructions reading from at least one source register and writing to at least one destination register. In block 404, the second-type integrity verifier 400 duplicates the duplication eligible instructions into duplicate instructions. In block 406, the second-type integrity verifier 400 inserts each of the duplicate instructions after each corresponding one of the original instructions.

The “DRDV” second-type integrity verifier 400 creates a shadow (e.g., duplicate virtual) register space for verifying the integrity of results produced by instructions that are not duplication eligible instructions. In block 408, the second-type integrity verifier 400 creates a shadow register for each source register of each of the original instructions. In block 410, the second-type integrity verifier 400 configures each of the duplicate instructions to read from each shadow register corresponding to each source register of the corresponding one of the original instructions.

Verification of the data flow through the instructions that are not duplication eligible instructions is accomplished by making comparisons in the shadow register space. In block 412, the second-type integrity verifier 400 copies an output of instructions that are not duplication eligible instructions to at least one of the shadow registers, verifying the integrity of source operands for the instructions that are not duplication eligible instructions by comparing values in the shadow registers (block 414), and alerting a runtime layer event handler in the event of a mismatch (block 416).

An optional optimization is to skip the verifying for values in the shadow registers that have not changed since a prior verification of those values.

The duplicate instruction is inserted after the original instruction and map the registers used by it into a shadow register space. For all non-duplicated copy eligible instructions, insert a move instruction to copy the destination register value into the shadow register space so that duplicated instructions can use it. Finally, insert verification instructions to check original and shadow register values for all inputs to non-duplicated instructions. This approach reduces the verification overhead (compared to the “SRIV” first-type integrity verifier 300) by chaining multiple replicated instructions on the path to a single verification.

An embodiment of an algorithm for implementing the second-type integrity verifier 400 is as follows:

```
create list of original instructions
clear original to shadow register mapping
for each instruction in the function do
  if instruction is duplication-eligible and original then
    duplicate instruction
    for all operands in the duplicate instruction do
      if shadow register does not exist then
        create a shadow register for the source
      end
    replace original register to shadow register
  end
  else if instruction is copy eligible and original then
    insert a move instruction copy the destination register value to the shadow space
  end
end
```

```
for each instruction in the function do
  if instruction is not duplication eligible and is original then
    for all sources in this instruction do
      verify original and shadow registers have same value
      if values are different then
        notify error to higher level (trap)
      end
    end
  end
end
```

The “DRDV” second-type integrity verifier 400 doubles the virtual register requirement per thread. Executing a code compiler's register allocator after the instruction duplication pass may reduce the real register usage per thread. However, the second-type integrity verifier 400 can result in significant execution slowdown for workloads in which the register file is a critical resource. This may either reduce the number of threads that run in parallel or increase the number of register spill/fill instructions that save/restore register content to/from local memory to limit the use of physical registers. If the total number of (original plus shadow) registers utilized exceeds the total available physical registers, some register values will need to be temporarily saved to memory (RAM) and later restored from memory. This process is referred to herein as spilling and filling. The first-type integrity verifier 300 provides a potential trade-off because it does not alter the original applications register requirement much, but it executes more dynamic instructions. This trade-off can benefit some workloads, especially when the register file is a critical resource.

A selection algorithm may be utilized by the compiler to analyze these tradeoffs for a particular code section and to select either first-type integrity verifier 300 or the second-type integrity verifier 400 for the code duplication technique accordingly.

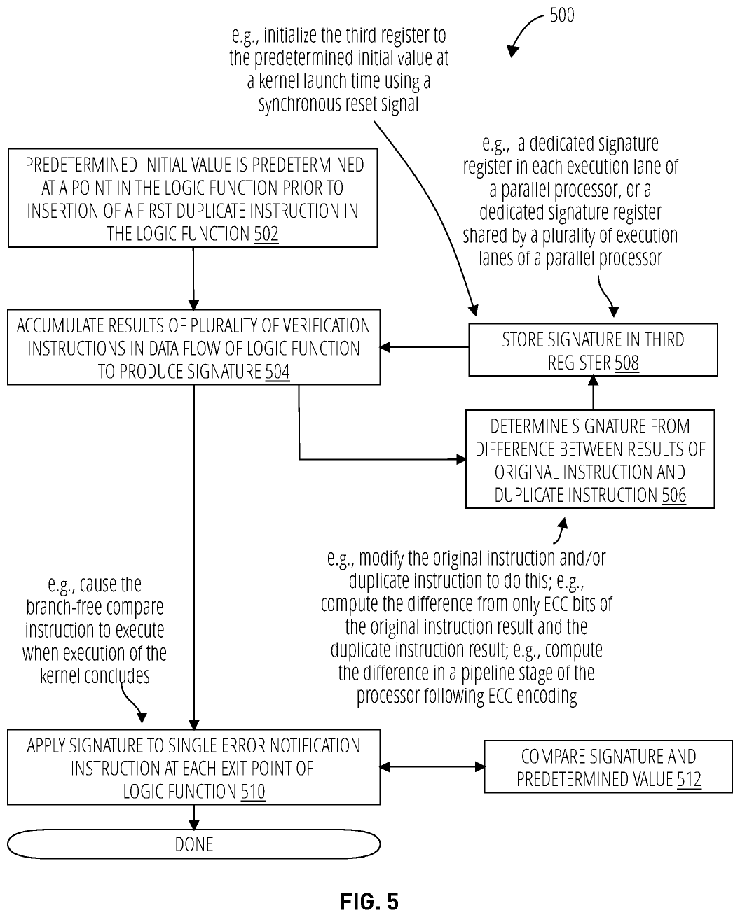

FIG. 5 depicts a third-type integrity verifier 500 (herein, also called “FastSig”) in accordance with one embodiment. The third-type integrity verifier 500 may be applied to reduce the overhead of the first- and second-type integrity verifiers 300 and 400. Instructions added to notify the upper layers of the system (e.g., adding a trap instruction) after every verification instruction can contribute significantly to performance overheads. To reduce this overhead, signature-based checking may be utilized.

In block 504, the “FastSig” third-type integrity verifier 500 accumulates results of a plurality of verification instructions in a data flow, e.g. for a particular logic function, to produce a signature (e.g., an up-down counter value). In block 510, the third-type integrity verifier 500 applies the signature to a single error notification instruction at each exit point of the logic function (e.g., the return or exit instruction of a function call or subroutine block of instructions).

Signature-based checking reduces the number of branch and trap instructions by accumulating (or chaining) the results to-be-verified instructions. A signature register (any physical or virtual register to hold the signature value) is initialized to a known value (e.g., zero) at the beginning of a logic function, and then the register values produced by each of the original instructions are added, and the results of duplicate instructions are subtracted, from this signature register. If the signature register is not equal to the initialized value at the end of the function, an error has occurred. If the signature update operations use fast and branch-free ISA instructions, this scheme can significantly reduce the error notification overhead from branch and trap instructions. A “branch-free compare instruction” refers to one or more instructions to compare two or more operands without possible causing a branch in execution flow.

The LOP3 operations supported by current NVIDIA GPUs is well suited for performing signature accumulation. The LOP3 instruction has three source operations and supports creating any logical function. It may be utilized to find the bit-wise difference between the destination registers of the original and duplicate instructions (using XOR), and then OR the result with the signature register to update it. During fault-free execution, the signature register will remain zero (if it was initialized to zero). The LOP3 instruction may be utilized to verify register values and update the signature register with use of only one high-throughput instruction.

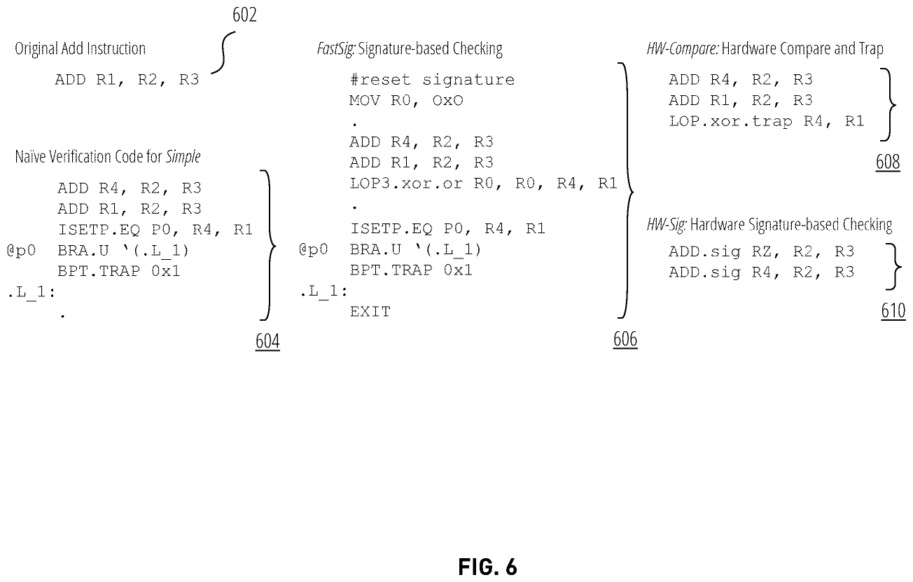

FIG. 6 depicts various logic for verifying data flow integrity in a data processor, for a single original ADD instruction 602.

The first-type integrity verifier 300 (“SRIV”) may in one embodiment generate naive verification logic 604. The second-type integrity verifier 400 (“DRDV”) removes redundant verifications of register values that did not change subsequently. The third-type integrity verifier 500 (“FastSig”) may in one embodiment generate the signature verification logic 606—note this includes logic to initialize the signature, which is only generated only at the start of the function (any block of instructions to verify), and the signature register check at the exit of the logic function. For the original ADD instruction 602, only the additional ADD and LOP3 instructions are inserted, with the other instructions generated once for all verified instructions in the data flow of the logic function.

Two additional logic blocks are illustrated for use with hardware acceleration. They are accelerated compare and trap logic 608, and accelerated signature checking logic 610. These are described in further detail below.

To accelerate performance, a new branch-free instruction (“HW-Notify”) that compares two values and raises a trap on a mismatch may be introduced. This instruction is shown in accelerated compare and trap logic 608 as LOP.xor.trap. This instruction can be used to accelerate both the first-type integrity verifier 300 (“SRIV”) and second-type integrity verifier 400 (“DRDV”). The instruction replaces the signature update operation (LOP3) used by the signature verification logic 606, and it avoids the need to maintain a signature register. It provides low-latency error detection with full error containment, as errors are detected and reported before they become erroneous values written to memory.

The HW-Notify instruction is similar to either a logical operation (LOP) or a compare operation (ISET) except that it does not need a destination register. Hardware changes to implement HW-Notify in a data processor, such as a GPU, include instruction decoder support for the new operation and some logic in the register write-back stage to raise a trap based on the results of a bit-wise equality check. One of ordinary skill in the art would readily understand how to implement such modifications and they will not be described further.

Another hardware acceleration technique maintains and updates a dedicated signature register in each execution lane (a parallel hardware instruction execution path) of the data processor. The original and duplicate instructions update the signature by accumulating and subtracting their destination register values, respectively. Example logic using this technique (“HW-Sig”) is accelerated signature checking logic 610. A “dedicated register” refers to a register for exclusive use by instructions in a particular execution lane.

One implementation of accelerated signature checking logic 610 uses binary Galois Field arithmetic (GF(2)) that employs XOR operations for signature accumulation and subtraction. GF(2) arithmetic is commutative, easy to design in hardware, and requires low die area overhead. One extra metadata bit may be utilized in the instruction to indicate whether the signature register should be updated by the results of the instruction. Instructions that are not duplicated do not update the signature.

Once the result is generated and is being written back to the destination register for an instruction that needs to update the signature, the accelerated signature checking logic 610 updates the signature register with the result in parallel such that it is not in a critical execution path. Hence, the write-back stage may be a desirable place to maintain and update the signature register.

Because instructions in many implementations can write to one or two 32-bit registers, a 64 bit signature register may be desirable. The signature register may be initialized to zero at the GPU kernel launch time (e.g., using a synchronous reset signal) and checked that it is zero at the end of the kernel's life. At the end of the kernel's life, the register checking logic may be activated. If the value is non-zero at the end of the kernel, a trap is raised. In this approach, only one signature register is needed per execution lane (not per thread), limiting the amount of storage needed per SM (SMs often support 1024 or 2048 threads).

To lower storage overhead, it may be desirable to accumulate the ECC bits of each result, instead of the result itself. In this implementation the signature register needs only to be as wide as the error code (e.g., 7 bit SEC-DED for 32 bit GPU registers). The signature update can take place in a pipeline stage following ECC encoding without performance concerns because this logic is not in the critical path of the data path.

An advantage of HW-Sig is that the hardware changes it requires are mostly limited to the write-back stage, making it a verification-friendly hardware change. This approach, however, does not detect the error until the end of the kernel's execution, which may be acceptable for workloads that execute many short running GPU kernels.

For code that executes on GPUs, and NVIDIA GPUs in particular, instruction replication can be implemented at several places in the compiler logic chain. While performing instruction replication early in the flow before PTX code is generated is perhaps easiest to implement algorithmically, later compiler optimization passes transform the program, changing the original code in ways that might eliminate some of the generated instructions.

Inserting the replicated and checking instructions directly into the compiler-generated SASS code ensures tight control over the final program binary, but involves re-implementation of logic that may already be implemented in the back-end compiler.

One solution is to implement the verification logic insertion within the back-end compiler (e.g., PTXAS), applying transformations on the intermediate logic generated there. The duplication algorithm runs after all the back-end optimizations are performed, but before the final instruction scheduling pass or register allocation. This approach leverages the production-quality instruction scheduler already implemented in the back-end compiler, which helps to lower the performance overheads of the duplication and verification code. It also enables instruction duplication on programs for which only the PTX code (rather than the original CUDA or OpenCL source code) is available.

FIG. 7 depicts a code compiler algorithm 700 and linker to generate executable logic for NVIDIA® GPUs in accordance with one embodiment. Code compiler algorithm 700 depicts one embodiment of the compilation flow for NVIDIA GPU programs, including the instruction duplication pass. The code compiler algorithm 700 comprises the input of source code files to NVCC 702, the input of the PTX output of NVCC to PTXAS 704, which in turn involves invoking subroutine PTAX compiler pass 706(further described in FIG. 8), and the input of the SASS output of PTXAS to NVLINK 708. Those familiar with NVIDIA GPU compilers will readily recognize these compiler and link stages. The code compiler algorithm 700 may be executed, for example, by the computing system 100.

Source programs are compiled using the front-end NVCC compiler to produce the virtual assembly code PTX. The back-end compiler PTXAS transforms the code into the final GPU-specific assembly code (SASS), which is then linked to libraries using the NVLINK linker. Instruction duplication runs after all the back-end optimizations in PTXAS. Although described for ahead-of-time compilation flow, a just-in-time (JIT) compiler can employ the same instruction duplication algorithms. The JIT compiler may be particularly well suited for auto-selection of the best technique for particular logic functions, as described below.

The algorithms to generate logic for the “SRIV” first-type integrity verifier 300, the “DRDV” second-type integrity verifier 400, or the “FastSig” third-type integrity verifier 500 operate at the intermediate representation (IR) in PTXAS, which is close in form to SASS assembly code. Because these algorithms run before register allocation, they operate on virtual registers and can easily create new registers which are later mapped to the limited set of physical registers.

In one embodiment, every duplication-eligible instruction is in fact duplicated, using a data-structure to track already-protected instructions so as not to duplicate them multiple times. Instructions that are not eligible for duplication include memory writes, control flow instructions, instructions that produce non-deterministic values, barrier spill/fill instructions, and instructions that write to pre-assigned physical registers.

Non-deterministic instructions—those where the replica and the original instruction would produce different values when executed—include S2R instructions that read special registers whose values change over time (e.g., the clock value), atomic operations, and volatile and non-cached memory reads. A load can be non-deterministic if there is a data race in the program.

Ideally, the code compiler algorithm 700 only marks the race-vulnerable loads as non-deterministic, however, identifying only this subset of loads is impractical. Instead, the code compiler algorithm 700 conservatively marks all generic, global, shared, texture, and surface loads as non-deterministic.

The code compiler algorithm 700 marks local and constant loads as deterministic because they can not participate in a data race by definition. Simple heuristics (that look for static atomic operations in a function) to identify loads that can potentially be non-deterministic are discussed further below.

A computer system may utilize logic to automatically select the algorithm (“SRIV” or “DRDV”) that is expected to perform better at kernel launch time and employ the superior code duplication scheme, using the JIT compilation flow. The prediction algorithm may input (1) an occupancy estimate using kernel specific parameters such as registers needed per thread, shared memory usage, thread block size, and target GPU resource constraints, and (2) the increase in the number of static instructions that would result from a particular duplication technique being applied, and (3) the increase in static spill/fill instructions that would result. A Decision Tree Classifier may work well for the prediction task given these inputs.

Additional optimizations may be utilized in some implementations to further lower the performance overhead of the code duplication techniques described herein. Examples are leveraging verifiable program invariants (e.g. low-cost program-level detectors to reduce the amount of duplicated code, and verifying the result of expensive instructions such as DIV and SQRT using lower-cost inverse functions instead of duplicating them. For example, the result of the SQRT instruction may be multiplied with itself to verify that the product is same as the original input. This approach has been used by concurrent hardware checkers before and it is similar in principle to the do-not-duplicate-MOVs optimization, only applied to a wider variety of instructions.

Referring to FIG. 8, in block 802, PTAX compiler pass 706 executes strength reduction. In block 804, PTAX compiler pass 706 executes loop unrolling. In block 806, PTAX compiler pass 706 executes dead code elimination. In block 808, PTAX compiler pass 706 executes instruction duplication. In block 810, PTAX compiler pass 706 executes additional dead code elimination. In block 812, PTAX compiler pass 706 schedules instructions. In block 814, PTAX compiler pass 706 allocates registers. In block 816, PTAX compiler pass 706 schedules instructions. In block 818, PTAX compiler pass 706 generates final SASS.

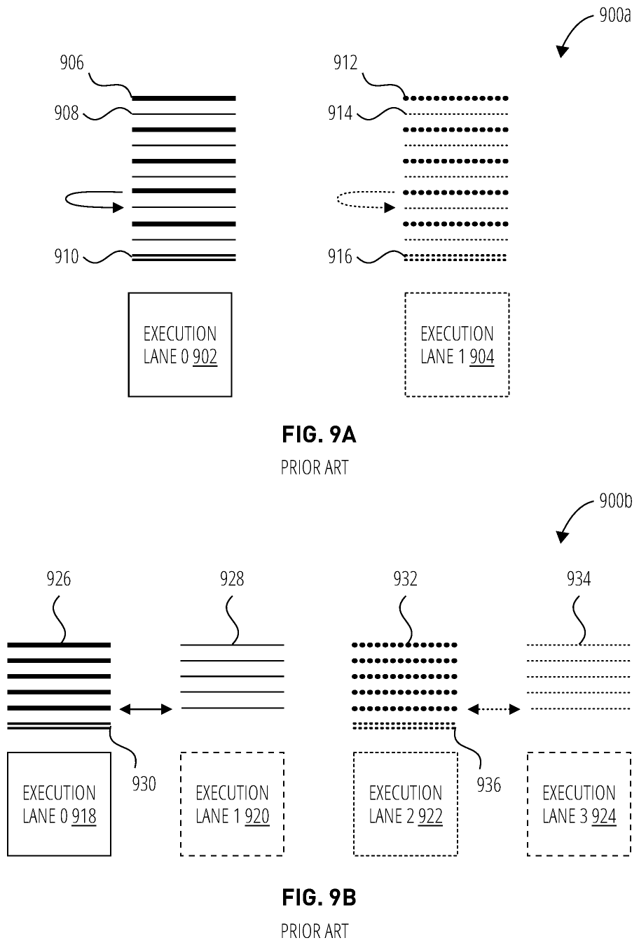

FIG. 9A depicts conventional instruction-level duplication 900a in accordance with one embodiment. In conventional instruction-level duplication 900a, an execution lane 0 902 of a multi-processor may execute lane 0 original instructions 906, lane 0 duplicate instructions 908, and lane 0 verification instructions 910. Execution lane 1 904 may execute lane 1 original instructions 912, lane 1 duplicate instructions 914, and lane 1 verification instructions 916.

Generally, the threads executing in different execution lanes may be divergent, meaning the original instructions of threads in different lanes may differ from one another.

Interleaved with lane 0 original instruction 906, execution lane 0 902 may execute a lane 0 duplicate instruction 908 that echoes each lane 0 original instruction 906, enabling verification that the instructions are issued and execute correctly by comparing results of the original and duplicate instruction. At or subsequent to the exit point of an instruction thread, execution lane 0 902 may execute lane 0 verification instructions 910 in order to verify that the outcomes of the lane 0 original instructions 906 and lane 0 duplicate instructions 908 match.

Similarly, interleaved with lane 1 original instruction 912, execution lane 1 904 may execute a lane 1 duplicate instruction 914 that echoes each lane 1 original instruction 912, enabling verification that the instructions are issued and executed correctly. At the exit point of the thread, execution lane 1 904 may execute lane 1 verification instructions 916 in order to verify that the outcomes of the lane 1 original instructions 912 and lane 1 duplicate instructions 914 match.

Verification using conventional instruction-level duplication 900a may reveal some errors in instruction processing but may fail to reveal errors caused by hardware flaws, such as a deterministic (e.g., inherent design) flaw in execution lane 0 902. A deterministic hardware flaw may create the same errors in the results of both the lane 0 original instructions 906 and lane 0 duplicate instructions 908, the lane 0 verification instructions 910 may show no difference in the outcomes of the two instruction sets, even if those outcomes are in error. This holds true for execution lane 1 904 as well.

Interleaving does not require that each and every original instruction is followed by a duplicate instruction. Duplicate instructions may be implemented for arithmetic instructions but may be omitted for memory instructions such as global and shared memory load and store instructions. Control instructions may also not be duplicated for the purposes of this solution. In this manner, the overhead of duplicating every instruction may be avoided, while still providing the ability for verification for arithmetic instructions which may be more vulnerable to error or failure than other types of instructions.

FIG. 9B depicts conventional thread level duplication 900b in accordance with one embodiment. In conventional thread level duplication 900b, an execution lane 0 918 may execute lane 0 original instructions 926 and lane 0 verification instructions 930, an execution lane 1 920 may execute lane 0 duplicate instructions 928, an execution lane 2 922 may execute lane 2 original instructions 932 and lane 2 verification instructions 936, and an execution lane 3 924 may execute lane 2 duplicate instruction 934. Generally, the verification instructions for an execution lane may be executed in either or both of the execution lane for the original instructions and/or the duplicate instructions. For verification, the data from the lane 0 duplicate instruction 928 in execution lane 1 920 is transferred to execution lane 0 918. This data transfer may for example be performed via memory or direct thread-to-thread transfers using interthread communication instructions (e.g., intra-warp communication instructions available in NVIDIA GPUs.

In this manner, separate hardware (execution lane 0 918 and execution lane 1 920) may be utilized to execute original and duplicate sets of instructions. When the lane 0 verification instructions 930 are processed, errors caused by a flaw inherent in either execution lane 0 918 or execution lane 1 920 may be revealed, in addition to other instruction issuing or execution errors.

Similarly, separate hardware (execution lane 2 922 and execution lane 3 924) may be utilized to process an original and duplicate set of instructions. When the lane 2 verification instructions 936 are executed, errors caused by a flaw inherent in either execution lane 2 922 or execution lane 3 924 may be revealed, in addition to other instruction issuing or execution errors.

Verification using conventional thread level duplication 900b may, therefore, reveal more errors than conventional instruction-level duplication 900a, but may cut in half the number of threads a system may process concurrently, or, to put it another way, it may use twice the hardware capacity, as each thread may fully take up two hardware lanes rather than one. This solution may be useful when underutilized hardware resources are available, but is otherwise constraining on performance.

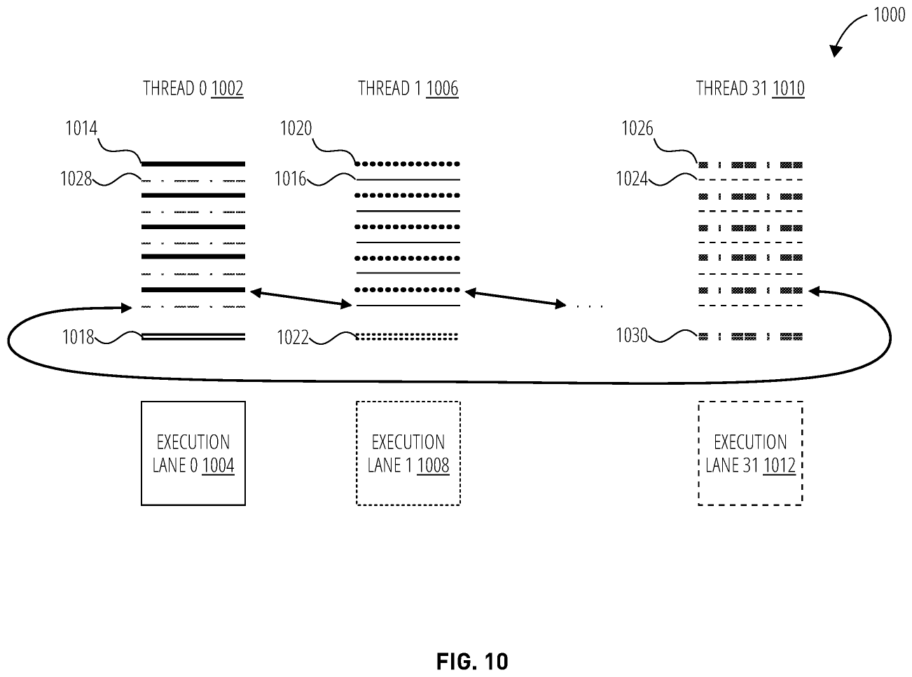

FIG. 10 depicts swizzled instruction duplication 1000 in accordance with one embodiment. Swizzled instruction duplication 1000 may be implemented using a plurality of execution lanes, each executing a thread of original instructions interleaved with duplicated instructions from a different execution lane. In the example, three of thirty-two execution lanes are depicted. Original instructions of thread 0 1002 are executed on execution lane 0 1004, original instructions of thread 1 1006 are executed on execution lane 1 1008, and so on, up to original instructions of thread 31 1010 being executed on execution lane 31 1012. The execution lanes between execution lane 1 1008 and execution lane 31 1012 have been omitted for simplicity but may behave as described for the lanes depicted. The solution disclosed herein is not intended to be limited to a particular number of execution lanes, such as thirty-two, but may be implemented on more or fewer execution lanes (e.g., N>1) in various embodiments.

In swizzled instruction duplication 1000, execution lane 0 1004 may execute thread 0 original instructions 1014 while execution lane 1 1008 executes thread 0 duplicate instructions 1016 alternately in an interleaved or semi-interleaved fashion with thread 1 original instructions 1020. As noted previously, “interleaved” execution of instructions does not require that every original instruction is followed by one duplicate instruction from another execution lane. Some instructions may not be duplicated, and in some embodiments the interleaving may not be 1:1.

Execution lane 0 1004 may process thread 0 verification instructions 1018 upon thread 0 1002 reaching an exit point, the thread 0 verification instructions 1018 comparing results of thread 0 original instructions 1014 executed on execution lane 0 1004 and results of thread 0 duplicate instructions 1016 executed on execution lane 1 1008. The comparison may be based on the results of both the original instruction and duplicate instruction execution, but may not necessarily utilize the literal results.

Similarly, execution lane 1 1008 may execute thread 1 original instructions 1020 while execution lane 2 (not shown) executes thread 1 duplicate instructions alternately with thread 2 original instructions. Execution lane 1 1008 may execute thread 1 verification instructions 1022 once thread 1 1006 has reached an exit point, comparing the results of thread 1 original instructions 1020 executed on execution lane 1 1008 and results of thread 1 duplicate instructions executed on execution lane 2.

This pattern may continue across the execution lanes, at which point a modulo shift may be utilized. Execution lane 31 1012 may execute thread 31 original instructions 1026 alternately with thread 30 duplicate instructions 1024, while execution of the thread 31 duplicate instructions 1028 wraps around to execution lane 0 1004. Execution lane 0 1004 executes thread 31 duplicate instructions 1028 alternately with thread 0 original instructions 1014. Execution lane 31 1012 may execute thread 31 verification instructions 1030 once thread 31 1010 has reached an exit point, comparing the results of thread 31 original instructions 1026 executed on execution lane 31 1012 and thread 31 duplicate instructions 1028 executed on execution lane 0 1004.

In general, the duplicate instructions for an execution lane need not be interleaved with original instructions of an adjacent execution lane, but may be interleaved into any other execution lane.

Swizzled instruction duplication 1000 may provide greater coverage and detection of potential hardware errors than conventional thread level duplication 900b, without reducing the number of threads that may be executed concurrently. For some types of hardware errors swizzled instruction duplication 1000 may provide additional diagnostic specificity. For example, if execution lane 0 1004 contained a hardware flaw that causes instructions executed on that lane to fail, this may be indicated by errors raised by thread 0 verification instructions 1018 as well as thread 31 verification instructions 1030. Such errors, seen in isolation, may be attributable to either execution lane 1 1008 or execution lane 31 1012 in addition to execution lane 0 1004. However, taken together, because execution lane 0 1004 is the common factor between potential errors raised by thread 0 verification instructions 1018 and thread 31 verification instructions 1030, the problem may be isolated to execution lane 0 1004.

As noted above, the adjacency depicted is not intended to limit the scope of this solution, as long as each thread to be verified using duplicate instructions has those duplicate instructions implemented on a different hardware execution lane. In some embodiments swizzling is confined to threads within a single warp; i.e., duplicate instructions are processed by hardware executing the warp comprising the original instructions. In other cases, which may involve more complicated thread scheduling and tracking algorithms, the duplicate instructions may be executed in a different warp. This may provide coverage and isolation of hardware errors arising from global symmetric multi-processor resources.

For example in some embodiments, duplicate instructions may be executed on a different symmetric multiprocessor (SM) than the original instructions in order to determine whether or not a failure may be caused by global SM resources utilized in all execution lanes of the SM. This may entail additional controls implemented on the scheduler unit. In embodiments executing concurrent thread arrays (CTAs) on an SM, persistent warps may be implemented in such a way that scheduling may not be impacted by executing duplicate instructions on a different SM than the original instructions.

In a synchronized execution environment the instructions executing on different execution lanes may be expected to complete at approximately the same time, such that result values for thread 0 original instructions 1014 and thread 0 duplicate instructions 1016 (for example) may be available at the approximately same time for comparison by thread 0 verification instructions 1018. In embodiments where this simultaneity may not be assumed, results from the original and duplicate instructions may be held in registers (shared or dedicated) until ready for comparison through the verification instructions.

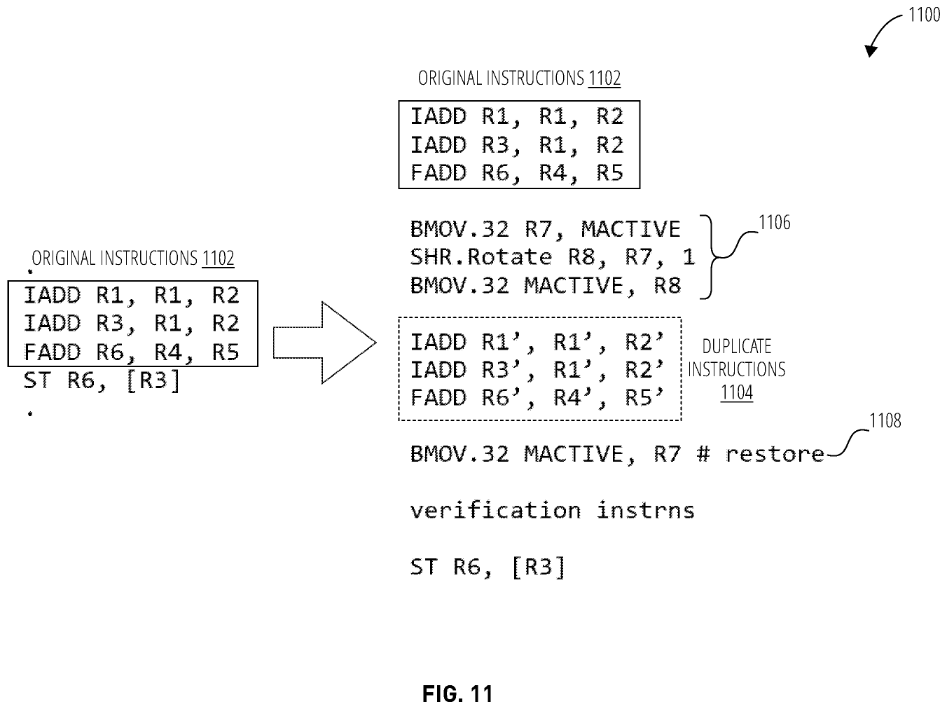

FIG. 11 depicts control divergence code 1100 in accordance with one embodiment. The original instructions 1102 may be augmented in this embodiment with duplicate instructions 1104, active mask swizzle instructions 1106, and active mask restore instructions 1108.

Control divergence may not be anticipated when the disclosed solution is implemented on fully converged warps. However, for warps that are not fully converged, a shifting of the active mask may be implemented to keep duplicate instructions executing on a thread that may have its original instructions masked while waiting for a return value.

For example, original instructions 1102 may include IADD and FADD instructions to be operated upon a number of registers, such as R1 through R6, as shown in the first three lines of the original instructions 1102. After these instructions are initiated, a move function (BMOV) may be initiated to move an active mask MACTIVE. For original instructions 1102 initiated on thread 0 1002 for example, the active mask may indicate that thread 0 1002 may be the active thread in order to perform at least one of the original instructions 1102. The active mask swizzle instructions 1106 may then act to move the active mask to thread 1 1006, where the duplicate instructions 1104 may be performed, moving the active mask off of thread 0 1002 as well.

Subsequent to the duplicate instructions 1104, active mask restore instructions 1108 may be issued to restore the active mask from thread 1 1006 to thread 0 1002. Duplicate instructions in thread i may be expected to have the same values as the original instructions of i−1. This allows the active mask to be shifted (rotated) right one thread between original instruction execution and duplicate instruction execution, such that the duplicate instructions may use their master thread's active mask. Verification instructions may be executed after the active mask is restored by the active mask restore instructions 1108, and a store instruction and a next set of original instructions may then be issued.

In this manner, thread 0 1002 original and duplicate instructions may be unmasked on both thread 0 1002 and thread 1 1006, while thread 1 1006 original and duplicate instructions may be masked on both thread 1 1006 and thread 2 (not shown). Because the active mask is moved using a modulo shift, it may be shifted from the last thread, such as thread 31 1010, around to thread 0 1002 when shifted “right” by one position. In some embodiments, the shifting of the active mask from a first thread executing original instructions and a second thread executing duplicate instructions may be implemented in hardware. In such an embodiment, the depicted active mask swizzle instructions 1106 and active mask restore instructions 1108 may not be needed. An additional bit or flag may be included on an instruction to indicate whether the first thread or the second thread is to be masked.

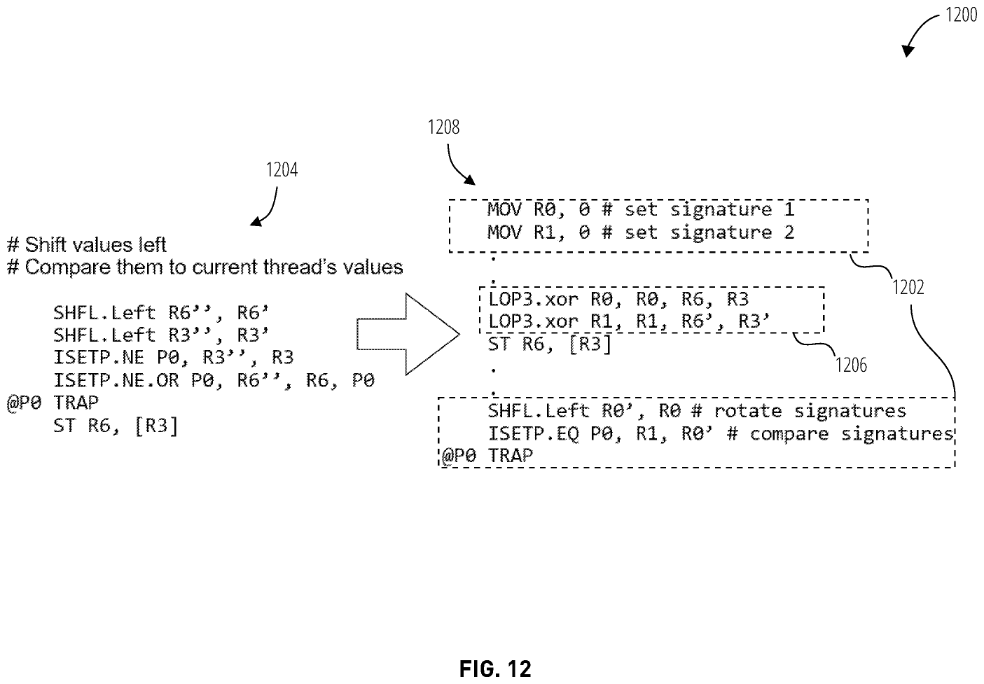

FIG. 12 on the left side depicts verification instructions 1204 which are executed after the active mask restore instructions 1108 depicted in FIG. 11. In an embodiment, the verification may involve executing intra-warp data movement instructions to transfer the register values computed by the duplicate instructions. For example on NVIDIA GPUs a warp shuffle (SHFL) instruction may be used for this purpose. The values computed by the original and duplicate instructions are compared (e.g., using an ISETP instruction), and based on the whether the values match, a trap instruction may be executed as a notification of an error detection. In one embodiment, the number of instructions required to transfer and compare can be optimized, which is depicted by the optimization 1208 on the right side of the FIG. 12. This optimization is described in more detail in FIG. 12.

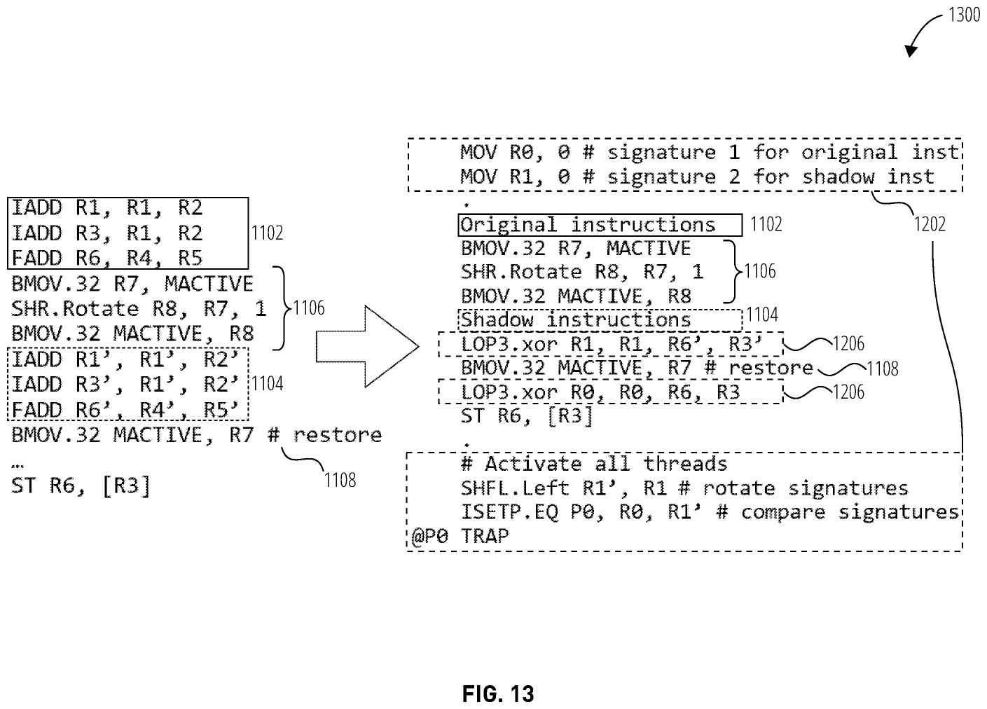

FIG. 13 depicts verification code 1300 in accordance with one embodiment. The lines of code introduced in FIG. 11 (original instructions 1102, duplicate instructions 1104, active mask swizzle instructions 1106, and active mask restore instructions 1108) may be augmented with verification instructions 1202 and XOR operation 1206.

The verification instructions 1202 may first include instructions for moving zero values as starting signatures for the original instructions and duplicate instructions into holding registers R0 and R1. After the duplicate instructions have been executed, a signature value for the duplicate instructions may be updated using the first XOR operation 1206 upon the output values of the duplicate instructions 1104. The active mask restore instructions 1108 restore the active mask to the master thread, and a second XOR operation 1206 upon the output values of the original instructions 1102 may be used to update the signature value for the original instructions.

A second set of verification instructions 1202 may be implemented once the signature values for the original instructions 1102 and the duplicate instructions 1104 have been updated. These instructions activate all threads, then rotate or shift the duplicate instructions 1104 signature values left for comparison with the original instructions 1102 signature values.

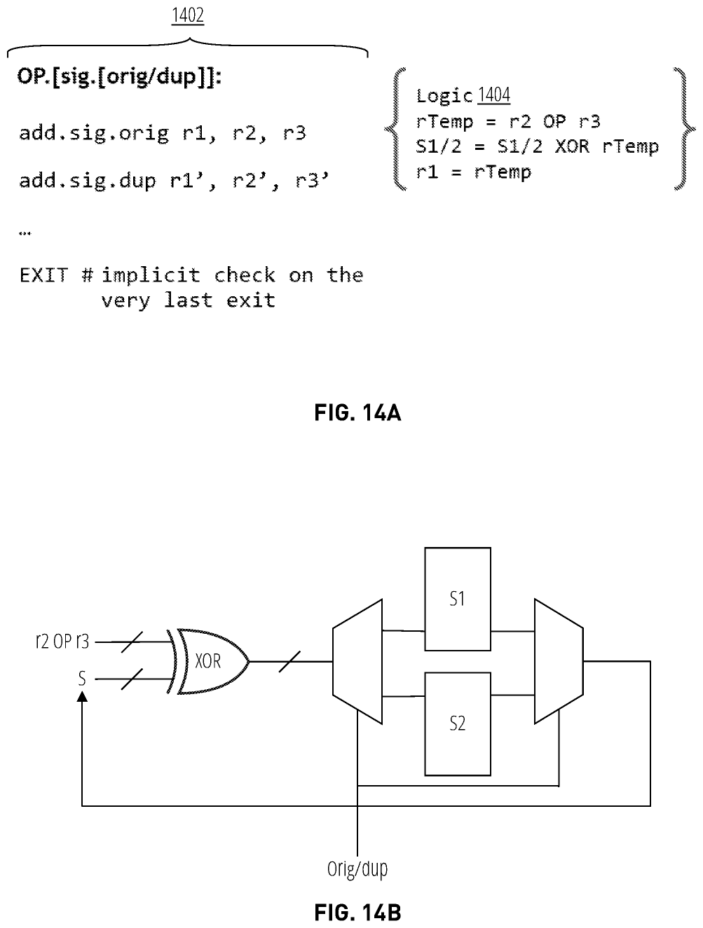

FIG. 14A depicts code providing a signature update capability. The OP function 1402 shown may be used instead of the XOR operations 1206 introduced in FIG. 13 for the purpose of updating the signature registers. The OP function 1402 may execute upon its operands following the logic 1404 illustrated.

Two hardware bits per instruction may be used to specify whether the instruction will update the hardware managed signature, and which signature to update. In this embodiment, two hardware signature values are stored in hardware, one for the original instructions and one for duplicate instructions. Example of how these two bits may be used is depicted by the OP function 1402. The OP function 1402 is a general operation (e.g., ADD) and the two additional bits may be depicted by .sig and .orig/.dup. The first bit (shown as .sig for 1 and absence of .sig for 0) is used to specify whether the instruction should update the signature or not. The second bit (shown as .orig for 0 or .dup for 1) is used to determine which signature to update and may also be used to determine the active mask to be used during instruction execution to avoid explicit active mask movement instructions. The logic 1404 depicts the functioning of an instruction when the .sig flag is used. It shows that the operation will produce a value depicted by rTemp and that this value is used to update the signature register. The value rTemp is then written directly to the destination register (depicted by r1) in the OP function 1402.

FIG. 14B depicts a hardware structure that may be used to implement a hardware-accelerated signature update, rather than running the OP function 1402 introduced in FIG. 14A. The hardware structures illustrated in FIG. 14B may be an XOR gate, multiplexers, and latches to hold S values as shown, or may be other configurations of hardware components able to perform the logic 1404 desired.

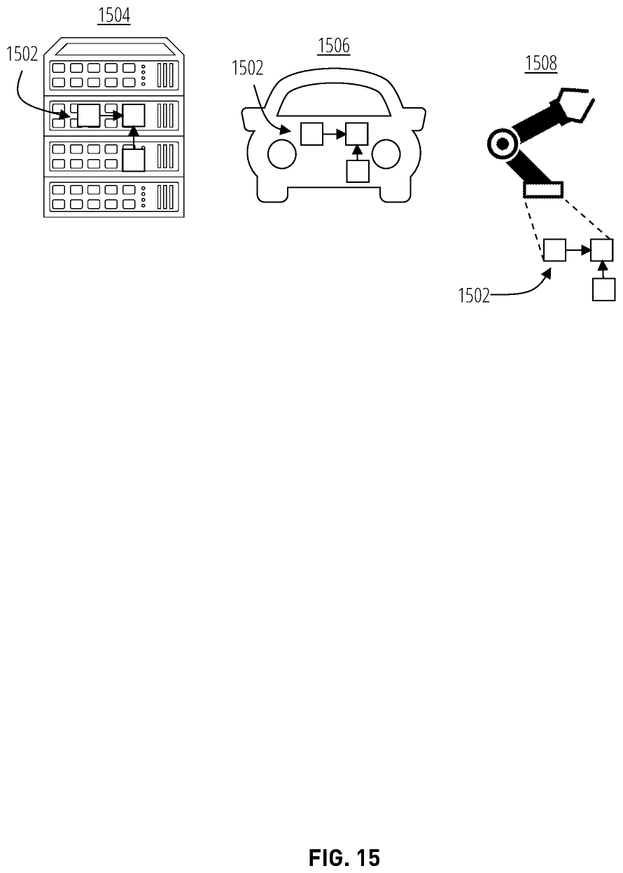

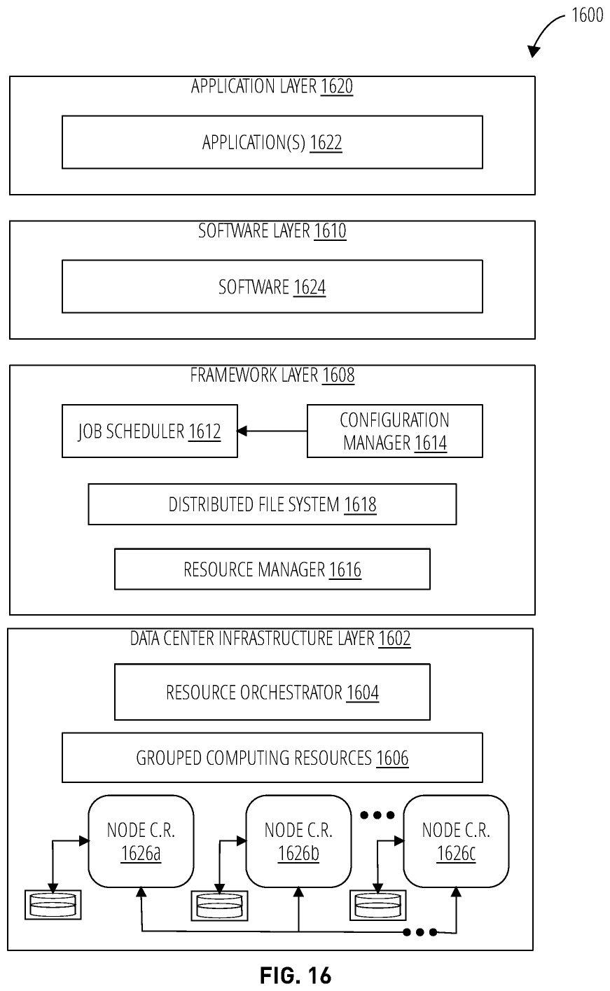

FIG. 15 depicts exemplary scenarios for a mission-critical control system 1502 in which embodiments in accordance with the disclosed logic and techniques may be applicable. A mission-critical control system 1502 may be utilized in a computing system 1504, a vehicle 1506, and a robot 1508, to name just a few examples. Other examples are super-computing applications, applications in space (e.g., satellite imaging and communications), complex computer modelling and simulation of physical phenomena, computer imaging applications (e.g., medical imaging), and data centers (e.g., see FIG. 16). The mission-critical control system 1502 may comprise one or more multi-processor to carry out important control functions for which hardware or software execution errors would have serious consequences. Utilizing embodiments in accordance with the disclosed logic and techniques may enable such errors to be detected and potentially corrected and thus improve the robustness of the mission-critical control system 1502.

On condition that the verification instructions detect an execution error, a number of remedial actions may be triggered, depending on the requirements and capabilities of the implementation. For example, execution of the original instructions and/or duplicate instructions of a thread may be suspended, may be moved to a different execution lane of the same or a different multi-processor, or may be duplicated on a third (or more) execution lanes of the same or a different multi-processor. Additionally or alternatively, an alert may be raised to an application so that the user or the application may take remedial action or additional analytics to identify a source of the error.

FIG. 16 depicts an exemplary data center 1600 in which embodiments in accordance with the disclosed techniques may be utilized, in accordance with at least one embodiment. In at least one embodiment, data center 1600 includes, without limitation, a data center infrastructure layer 1602, a framework layer 1608, software layer 1610, and an application layer 1620.

In at least one embodiment, as depicted in FIG. 16, data center infrastructure layer 1602 may include a resource orchestrator 1604, grouped computing resources 1606, and node computing resources (“Node C.R.s”) Node C.R. 1626a, Node C.R. 1626b, Node C.R. 1626c, . . . Node Node C.R. N), where “N” represents any whole, positive integer. In at least one embodiment, Node C.R.s may include, but are not limited to, any number of central processing units (“CPUs”) or other processors (including accelerators, field programmable gate arrays (“FPGAs”), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more Node C.R.s from among Node C.R.s may be a server having one or more of above-mentioned computing resources. Embodiments of the techniques disclosed herein may be utilized for example in one or more of the Node C.R.s.

In at least one embodiment, grouped computing resources 1606 may include separate groupings of Node C.R.s housed within one or more racks (not shown), or many racks housed in data centers at various geographical locations (also not shown). Separate groupings of Node C.R.s within grouped computing resources 1606 may include grouped compute, network, memory or storage resources that may be configured or allocated to support one or more workloads. In at least one embodiment, several Node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 1604 may configure or otherwise control one or more Node C.R.s and/or grouped computing resources 1606. In at least one embodiment, resource orchestrator 1604 may include a software design infrastructure (“SDI”) management entity for data center 1600. In at least one embodiment, resource orchestrator 1604 may include hardware, software or some combination thereof.

In at least one embodiment, as depicted in FIG. 16, framework layer 1608 includes, without limitation, a job scheduler 1612, a configuration manager 1614, a resource manager 1616, and a distributed file system 1618. In at least one embodiment, framework layer 1608 may include a framework to support software 1624 of software layer 1610 and/or one or more application(s) 1622 of application layer 220. In at least one embodiment, software 1624 or application(s) 1622 may respectively include web-based service software or applications, such as those provided by Amazon Web Services, Google Cloud and Microsoft Azure. In at least one embodiment, framework layer 1608 may be, but is not limited to, a type of free and open-source software web application framework such as Apache Spark™ (hereinafter “Spark”) that may utilize a distributed file system 1618 for large-scale data processing (e.g., “big data”). In at least one embodiment, job scheduler 1612 may include a Spark driver to facilitate scheduling of workloads supported by various layers of data center 1600. In at least one embodiment, configuration manager 1614 may be capable of configuring different layers such as software layer 1610 and framework layer 1608, including Spark and distributed file system 1618 for supporting large-scale data processing. In at least one embodiment, resource manager 1616 may be capable of managing clustered or grouped computing resources mapped to or allocated for support of distributed file system 1618 and distributed file system 1618. In at least one embodiment, clustered or grouped computing resources may include grouped computing resources 1606 at data center infrastructure layer 1602. In at least one embodiment, resource manager 1616 may coordinate with resource orchestrator 1604 to manage these mapped or allocated computing resources.

In at least one embodiment, software 1624 included in software layer 1610 may include software used by at least portions of Node C.R.s, grouped computing resources 1606, and/or distributed file system 1618 of framework layer 1608. One or more types of software may include, but are not limited to, Internet web page search software, e-mail virus scan software, database software, and streaming video content software.

In at least one embodiment, application(s) 1622 included in application layer 1620 may include one or more types of applications used by at least portions of Node C.R.s, grouped computing resources 1606, and/or distributed file system 1618 of framework layer 1608. The one or more types of applications may include, without limitation, CUDA applications, 5G network applications, artificial intelligence applications, data center applications, and the various mission critical applications mentioned previously, and/or variations thereof.

In at least one embodiment, any of configuration manager 1614, resource manager 1616, and resource orchestrator 1604 may implement any number and type of self-modifying actions based on any amount and type of data acquired in any technically feasible fashion. In at least one embodiment, self-modifying actions may relieve a data center operator of data center 1600 from making possibly bad configuration decisions and possibly avoiding underutilized and/or poor performing portions of a data center.

Terms used herein should be accorded their ordinary meaning in the relevant arts, or the meaning indicated by their use in context, but if an express definition is provided, that meaning controls.

“Circuitry” refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” refers to software logic embodied as processor-executable instructions stored in read-only memories or media.

“Hardware” refers to logic embodied as analog or digital circuitry.

“Logic” refers to machine memory circuits, non-transitory machine-readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

The techniques and integrity verifiers disclosed herein may be implemented by logic in various combinations of hardware, software, and firmware, depending on the requirements of the particular implementation.

“Programmable device” refers to an integrated circuit (hardware) designed to be configured and/or reconfigured after manufacturing. The term “programmable processor” is another name for a programmable device herein. Programmable devices may include programmable processors, such as field programmable gate arrays (FPGAs), configurable hardware logic (CHL), and/or any other type programmable devices. Configuration of the programmable device is generally specified using a computer code or data such as a hardware description language (HDL), such as for example Verilog, VHDL, or the like. A programmable device may include an array of programmable logic blocks and a hierarchy of reconfigurable interconnects that allow the programmable logic blocks to be coupled to each other according to the descriptions in the HDL code. Each of the programmable logic blocks may be configured to perform complex combinational functions, or merely simple logic gates, such as AND, and XOR logic blocks. In most FPGAs, logic blocks also include memory elements, which may be simple latches, flip-flops, hereinafter also referred to as “flops,” or more complex blocks of memory. Depending on the length of the interconnections between different logic blocks, signals may arrive at input terminals of the logic blocks at different times.

“Software” refers to logic implemented as processor-executable instructions in a machine memory (e.g. read/write volatile or nonvolatile memory or media).

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

Those skilled in the art will recognize that it is common within the art to describe devices or processes in the fashion set forth herein, and thereafter use standard engineering practices to integrate such described devices or processes into larger systems. At least a portion of the devices or processes described herein can be integrated into a network processing system via a reasonable amount of experimentation. Various embodiments are described herein and presented by way of example and not limitation.

Those having skill in the art will appreciate that there are various logic implementations by which processes and/or systems described herein can be effected (e.g., hardware, software, or firmware), and that the preferred vehicle will vary with the context in which the processes are deployed. If an implementer determines that speed and accuracy are paramount, the implementer may opt for a hardware or firmware implementation; alternatively, if flexibility is paramount, the implementer may opt for a solely software implementation; or, yet again alternatively, the implementer may opt for some combination of hardware, software, or firmware. Hence, there are numerous possible implementations by which the processes described herein may be effected, none of which is inherently superior to the other in that any vehicle to be utilized is a choice dependent upon the context in which the implementation will be deployed and the specific concerns (e.g., speed, flexibility, or predictability) of the implementer, any of which may vary. Those skilled in the art will recognize that optical aspects of implementations may involve optically-oriented hardware, software, and or firmware.

Those skilled in the art will appreciate that logic may be distributed throughout one or more devices, and/or may be comprised of combinations memory, media, processing circuits and controllers, other circuits, and so on. Therefore, in the interest of clarity and correctness logic may not always be distinctly illustrated in drawings of devices and systems, although it is inherently present therein. The techniques and procedures described herein may be implemented via logic distributed in one or more computing devices. The particular distribution and choice of logic will vary according to implementation.

In a general sense, those skilled in the art will recognize that the various aspects described herein which can be implemented, individually or collectively, by a wide range of hardware, software, firmware, or any combination thereof can be viewed as being composed of various types of circuitry.

What is claimed is:

1. A thread execution method comprising:
executing original instructions of a first thread in a first execution lane of a processor; and
interleaving execution of duplicated instructions of the first thread with execution of original instructions of a second thread in a second execution lane of the processor.

2. The thread execution method of claim 1, further comprising:
interleaving execution of duplicated instructions of a third thread with execution of the original instructions of the first thread in the first execution lane of the processor.

3. The thread execution method of claim 1, further comprising:
performing an integrity verification on results of the execution of the original instructions of the first thread and results of the execution of the duplicated instructions of the first thread.

4. The thread execution method of claim 3, further comprising:
on condition that the verification instructions detect an execution error, performing one or more of:
moving execution of the original instructions of the first thread to a different execution lane than the first execution lane of the processor;
moving execution of the duplicate instructions of the first thread to a different execution lane than the second execution lane of the processor; and
duplicating and executing the original instructions of the first thread on a third or more execution lanes of the processor.

5. The thread execution method of claim 3, wherein the integrity verification is triggered by reaching an exit point of the first thread.

6. The thread execution method of claim 1, further comprising, for each of threads i, where i=1 to N (N≥2):
executing original instructions of thread i in an i^{th} execution lane of the processor;
interleaving execution of duplicated instructions of thread i with execution of original instructions of thread i+1 in an (i+1)^{th} execution lane of the processor.

7. The thread execution method of claim 6, further comprising:
interleaving execution of duplicated instructions of a thread N+1 with execution of original instructions of the first thread in the first execution lane of the processor.

8. The thread execution method of claim 1, further comprising:
performing a shift of an active thread mask across execution lanes of the processor.

9. The thread execution method of claim 8, wherein the shift is a modulo shift.

10. A system comprising:
a multi-processor comprising a first execution lane, a second execution lane, and a third execution lane;
logic to interleave execution by the multi-processor of duplicated instructions of a first thread in the first execution lane with execution by the multi-processor of original instructions of a second thread in the second execution lane; and
logic to interleave execution by the multi-processor of duplicated instructions of the second thread with execution by the multi-processor of original instructions of a third thread in the third execution lane.

11. The system of claim 10, further comprising:
logic to interleave execution by the multi-processor of duplicated instructions of the third thread with execution of the original instructions of the first thread in the first execution lane.

12. The system of claim 10, further comprising:
logic to perform a comparison of results of the execution of the original instructions of the first thread and results of the execution of the duplicated instructions of the first thread; and
logic to raise an error alert based on the comparison.

13. The system of claim 12, wherein the comparison is triggered as a result of reaching an exit point of the first thread.

14. The system of claim 10, further comprising:
logic to execute original instructions of thread i in an i^{th} execution lane of the multi-processor, for each of threads i, where i=1 to N (N>2);
logic to interleave execution by the multi-processor of duplicated instructions of thread i with execution by the multi-processor of original instructions of thread i+1 in an (i+1)^{th} execution lane of the multi-processor, for each of threads i, where i=1 to N (N>2).

15. The system of claim 14, further comprising:
logic to interleave execution by the multi-processor of duplicated instructions of a thread N+1 with execution of the original instructions of the first thread in the first execution lane.

16. The system of claim 10, further comprising:
logic to perform a shift of an active thread mask across execution lanes of the multi-processor.

17. The system of claim 16, wherein the shift is a modulo shift.

18. A parallel processor comprising:
logic to duplicate original instructions of a first thread executing in a first execution lane of a processor into duplicate instructions and to interleave the duplicate instructions between original instructions of a second thread executing in a second execution lane of the processor;
logic to accumulate first results for the original instructions of the first thread;
logic to accumulate second results for the duplicate instructions;
logic to perform a test, subsequent to an exit point of the first thread, based on the first results and the second results; and
logic to raise an alert if the test meets a condition.

19. The parallel processor of claim 18, further comprising:
a dedicated register for each of the execution lanes in which to accumulate the first results and the second results respectively.

20. The parallel processor of claim 18, further comprising:
a shared register for the execution lanes in which to accumulate the first results and the second results.

21. The parallel processor of claim 20, further comprising:
logic to initialize the shared register to a predetermined initial value at a kernel launch time using a synchronous reset signal and to perform the test when execution of the kernel concludes.

22. The parallel processor of claim 18, further comprising logic for binary Galois Field arithmetic utilizing XOR operations to compute the first results and the second results.

23. The parallel processor of claim 18, further comprising:
logic to base the test only ECC bits of the first results and the second results.

24. The parallel processor of claim 23, further comprising:
logic to perform the test in a pipeline stage of the parallel processor following ECC encoding.

25. A thread execution method comprising:
in one or more of a a self-driving car, a robot, or an imaging system comprising at least one processor:
executing original instructions of a first thread in a first execution lane of the at least one processor; and
interleaving execution of duplicated instructions of the first thread with execution of original instructions of a second thread in a second execution lane of the at least one processor.

26. The thread execution method of claim 25, further comprising:
performing an integrity verification on results of the execution of the original instructions of the first thread and results of the execution of the duplicated instructions of the first thread.

27. The thread execution method of claim 26, further comprising:
on condition that the verification instructions detect an execution error, performing one or more of:
moving execution of the original instructions of the first thread to a different execution lane than the first execution lane of the at least one processor;
moving execution of the duplicate instructions of the first thread to a different execution lane than the second execution lane of the at least one processor; and
duplicating and executing the original instructions of the first thread on a third or more execution lanes of the at least one processor.

28. A data center comprising:
a plurality of computer systems, each comprising at least one multi-processor; and
logic to configure the multi-processor of one or more of the computer systems to:
execute original instructions of a first thread in a first execution lane of the multi-processor; and
interleave execution of duplicated instructions of the first thread with execution of original instructions of a second thread in a second execution lane of the multi-processor.

29. The data center of claim 28, the logic to further configure the multi-processor to perform an integrity verification on results of the execution of the original instructions of the first thread and results of the execution of the duplicated instructions of the first thread.

30. The data center of claim 29, the logic to further configure the multi-processor to:
on condition that the verification instructions detect an execution error, perform one or more of:
move execution of the original instructions of the first thread to a different execution lane than the first execution lane of the at least one processor;
move execution of the duplicate instructions of the first thread to a different execution lane than the second execution lane of the at least one processor; and
duplicate and execute the original instructions of the first thread on a third or more execution lanes of the at least one processor.
